(19) United States
(12) Patent Application Publication
(10) Pub. No.: US 2016/0294625 A1
(43) Pub. Date: Oct. 6, 2016

(54) METHOD FOR NETWORK MONITORING USING EFFICIENT GROUP MEMBERSHIP TEST BASED RULE CONSOLIDATION

(71) Applicant: Telefonaktiebolaget L M Ericsson (publ), Stockholm (SE)

(72) Inventors: Heikki Mahkonen, San Jose, CA (US); Ravi Manghirmalani, Fremont, CA (US); Meral Shirazipour, San Jose, CA (US); Ming Xia, San Jose, CA (US)

(21) Appl. No.: 14/744,736

(22) Filed: Jun. 19, 2015

Related U.S. Application Data
(60) Provisional application No. 62/140,932, filed on Mar. 31, 2015.

(51) Int. Cl. H04L 12/24; H04L 29/08; H04L 12/26

(52) U.S. Cl. CPC H04L 41/0893; H04L 43/04; H04L 67/1044

(57) ABSTRACT

Exemplary methods include determining to consolidate a plurality of rules, each comprising a match field and an action field, the action field identifying an action to be performed on packets identified by the match field. The methods include determining a size of a group membership (GM) vector and a false positive rate. The methods include selecting hash functions, wherein a number of hash functions selected is determined based on the GM vector size and the number of rules in the plurality of rules. The methods include updating the GM vector based the plurality of rules and the selected hash functions, generating a consolidated rule comprising of a GM match field and a GM action field, wherein the GM match field comprises the GM vector, wherein the GM action field identifies an action to be performed on packets identified by the GM match field, and sending the consolidated rule.

### CROSS-REFERENCE TO RELATED APPLICATIONS

This application claims the benefit of U.S. Provisional Application No. 62/140,932, filed Mar. 31, 2015, which is hereby incorporated by reference.

### FIELD

Embodiments of the invention relate to the field of packet networks, and more specifically, to efficient group membership test (e.g., bloom filter, cuckoo hash, etc.) based rule consolidation.

### BACKGROUND

Software-Defined Networking (SDN) defines a networking architecture wherein the control and data planes are decoupled. Such an architecture allows a logically centralized controller to control multiple data plane switches. The OpenFlow (OF) protocol is defined by the OpenFlow Switch Specification, version 1.3.0, Jun. 25, 2012 (which is hereby incorporated by reference in its entirety). The OF protocol allows SDN controllers to control and monitor data plane switches that support OpenFlow. The OF protocol describes the packet forwarding abstraction required from each data plane switch and the communication protocol to program their packet forwarding. The desired packet forwarding behavior can be achieved by programming OF rules to the packet-forwarding pipeline. Each OF rule typically comprises of a match field and an action field. The match field dictates to which incoming packets the action needs to be applied and the action field holds the packet processing instructions that need to be applied. Each incoming packet is processed by the OF switch by applying the actions corresponding to the matching flow rule.

In large-scale network deployments, the number of OF rules in a single OF switch can become very large. In addition, the switch will often need to store additional bookkeeping related information associated with each rule, for example, the packet and byte counters and timers. The required resources for each OF rule in a OF switch directly depends on the overall capabilities of the switch—the number of rules supported and the associated counters and timer granularities. For some network management applications, monitoring counters and timers might be the key process to learn what is going on in the network as well as in each individual switch.

The OpenFlow protocol does not provide an effective way of consolidating match fields other than the use of wildcards. Longest prefix match (LPM), however, is not suitable for consolidating 5-tuple-match rules if Internet Protocol (IP) addresses belong different prefixes. Therefore, in deployments which require 5-tuple classifications, the result is large amounts of fine-grained match OF rules, and thus, requiring a substantial amount of resources. OpenFlow defines the concept of a “group table” that comprises of group entries, wherein each group entry includes a group identifier, group type, counters, and action buckets. Group tables are useful for grouping actions. Group tables, however, do not help in consolidating the rule match fields. Thus, there is a need for an efficient mechanism to consolidate rule match fields.

### SUMMARY

Exemplary methods performed by a first network device that is communicatively coupled to a second network device, for consolidating rules, include determining to consolidate a plurality of rules, wherein each rule comprises a match field and an action field, wherein the action field identifies an action to be performed on packets identified by the match field. The methods include determining a size of a group membership (GM) vector based on a number of rules in the plurality of rules, and determining a false positive rate. The methods include selecting one or more hash functions, wherein a number of hash functions selected is determined based on the GM vector size and the number of rules in the plurality of rules, and updating the GM vector based the plurality of rules and the selected hash functions. The methods include generating a consolidated rule comprising of a GM match field and a GM action field, wherein the GM match field comprises the GM vector, wherein the GM action field identifies an action to be performed on packets identified by the GM match field, and sending the consolidated rule to the second network device.

According to one embodiment, the methods include negotiating with the second network device to determine that the second network device can support the determined GM vector size and the selected hash functions.

According to one embodiment, the methods include selecting hash function parameters comprising of a seed and a prime for each of the selected hash functions, and negotiating with the second network device to determine that the second network device can support the selected hash function parameters.

According to one embodiment, the GM match field of the consolidated rule further comprises information identifying the selected hash functions.

According to one embodiment, updating the GM vector comprises for each of the plurality of rules, applying the selected one or more hash functions to obtain one or more hash values, and setting one or more bits in the GM vector based on the determined one or more hash values.

Exemplary methods performed by a first network device that is communicatively coupled to a second network device, for consolidating rules, include negotiating with the second network device to determine a size of a group membership (GM) vector, and receiving a consolidated rule comprising of a GM match field and a GM action field, wherein the GM match field comprises the GM vector, wherein the GM action field identifies an action to be performed on packets identified by the GM match field.

According to one embodiment, the methods include in response to receiving a packet, determining one or more hash values by applying one or more hash functions on one or more bytes in a header of the received packet, updating a second GM vector based on the determined one or more hash values, and determining whether to perform the action identified by the GM action field on the packet based on whether the second GM vector matches the GM vector included in the GM match field of the received consolidated rule.

According to one embodiment, the methods include updating one or more counters identified by the determined one or more hash values.

According to one embodiment, the methods include negotiating with the second network device to determine the one or more hash functions, and wherein the GM match field of the received consolidated rule further comprises information identifying the one or more hash functions.

### BRIEF DESCRIPTION OF THE DRAWINGS

The invention may best be understood by referring to the following description and accompanying drawings that are used to illustrate embodiments of the invention. In the drawings:

FIG. 1 is a block diagram a illustrating network according to one embodiment.

FIG. 2 is a transaction diagram illustrating operations for performing rule consolidation using a group membership according to one embodiment.

FIG. 3 is a flow diagram illustrating a method for consolidating rules using a group membership according to one embodiment.

FIG. 4 is a flow diagram illustrating a method for consolidating rules using a group membership according to one embodiment.

FIG. 5A illustrates connectivity between network devices (NDs) within an exemplary network, as well as three exemplary implementations of the NDs, according to some embodiments of the invention.

FIG. 5B illustrates an exemplary way to implement a special-purpose network device according to some embodiments of the invention.

FIG. 5C illustrates various exemplary ways in which virtual network elements (VNEs) may be coupled according to some embodiments of the invention.

FIG. 5D illustrates a network with a single network element (NE) on each of the NDs, and within this straight forward approach contrasts a traditional distributed approach (commonly used by traditional routers) with a centralized approach for maintaining reachability and forwarding information (also called network control), according to some embodiments of the invention.

FIG. 5E illustrates the simple case of where each of the NDs implements a single NE, but a centralized control plane has abstracted multiple of the NEs in different NDs into (to represent) a single NE in one of the virtual network(s), according to some embodiments of the invention.

FIG. 5F illustrates a case where multiple VNEs are implemented on different NDs and are coupled to each other, and where a centralized control plane has abstracted these multiple VNEs such that they appear as a single VNE within one of the virtual networks, according to some embodiments of the invention.

FIG. 6 illustrates a general purpose control plane device with centralized control plane (CCP) software), according to some embodiments of the invention.

### DESCRIPTION OF EMBODIMENTS

The following description describes methods and apparatus for performing rule consolidation based on a group membership test. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

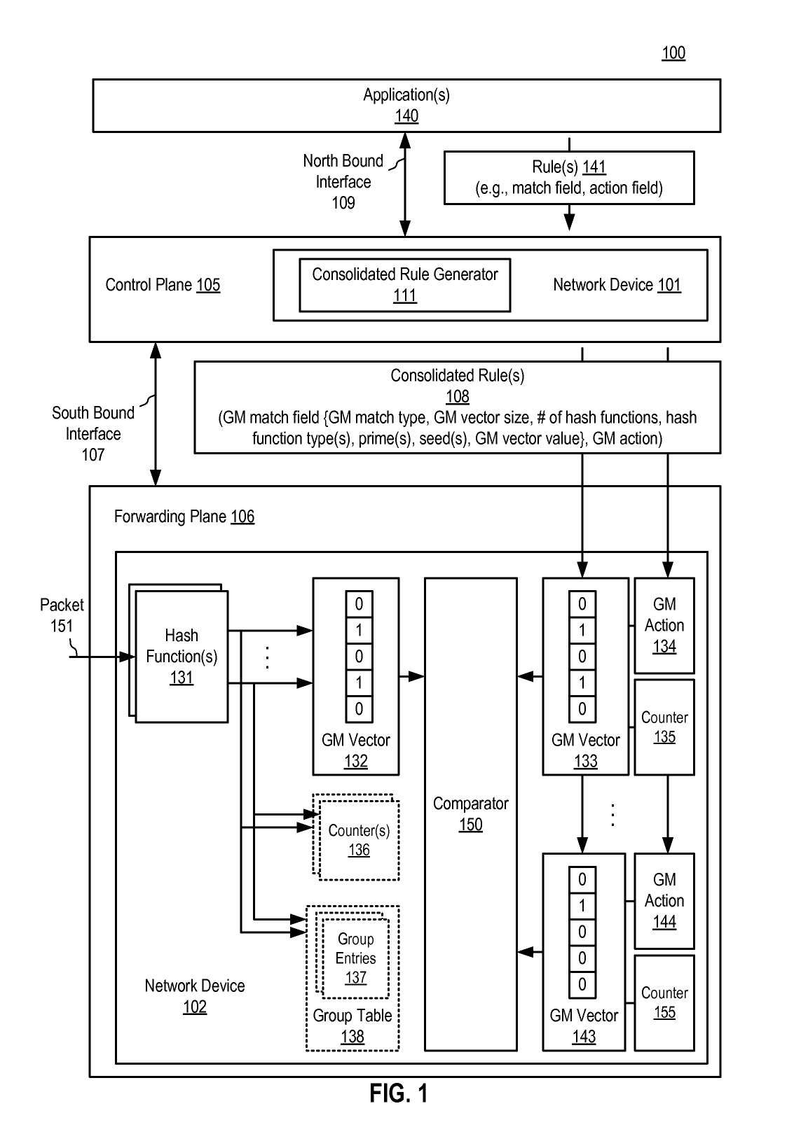

FIG. 1 is a block diagram illustrating network 100 according to one embodiment. Network 100 includes control plane 105 and forwarding plane 106. In the illustrated embodiment, control plane 105 includes network device 101, and forwarding plane 106 includes network device 102. It shall be understood, however, that more network devices can be included as part of control plane 105 and/or forwarding plane 106. In one embodiment, network device 101 of control plane 105 communicates with network device 102 of forwarding plane 106 via southbound interface (SBI) 107 using protocols such as Forwarding and Control Element Separation (ForCES), Network Configuration Protocol (NETCONF), and Interface to the Routing System (I2RS). Other protocols, however, can be utilized to implement SBI 107 without departing from the broader scope and spirit of the present invention.

Control plane 105 is further communicatively coupled to application(s) 140, which can be, for example, SDN applications such as orchestration, monitoring, etc. Network device 101 of control plane 105 communicates with application(s) 140 via north bound interface (NBI) 109, using protocols similar to those described above with respect to SBI 107. Applications 140, in one embodiment, send rules 141 (e.g., OF rules) to the network devices (e.g., network device 101) of control plane 105. Each of rules 141 includes, but is not limited to, a match field and an action field, wherein the action field identifies an action to be performed on packets identified by the match field. For example, the match field may comprise of up to 5 tuple (e.g., source Internet Protocol (IP) address, destination IP address, source port, destination port, and protocol identifier (ID)). Conventionally, the control plane may consolidate the rules prior to installing (i.e., sending) them to the forwarding plane. The conventional consolidation approach, however, is simplistic and does not apply in most cases, thus requiring the forwarding plane to utilize a substantial amount of resources to accommodate all the rules. Embodiments of the present invention overcome such limitations by providing mechanisms for performing rule consolidating using group membership (GM) tests.

A hash based GM vector (e.g., Bloom Filter, Cuckoo, etc.) is a space-efficient probabilistic data structure that is used to test whether an element is a member of a set. False positive matches are possible, but false negatives are not, thus a GM has a 100% recall rate. In other words, a query returns either “possibly in the set” or “definitely not in the set”. When bloom filters are used, elements can be added to the set, but not removed. Other GM methods (e.g., Cuckoo) allow elements to be removed from the set. The more elements that are added to the set, the larger the probability of false positives.

An empty GM vector is a bit array of m bits, all set to “0”. There must also be k different hash functions defined, each of which maps or hashes an element to one of the m array positions with a uniform random distribution. To add an element, the algorithm requires applying the k hash functions on the element to get k array positions, and set the bits at all these positions to “1”. To query for an element (i.e., determine whether it is in the set), the algorithm requires applying the same k hash functions on the element to get k array positions. If any of the bits at these positions is “0”, the element is definitely not in the set—if it was in the set, then all the bits would have been set to “1” when it was inserted. If all the bits at these positions are “1”, then either the element is in the set, or the bits have by chance been set to “1” during the insertion of other elements, resulting in a false positive. In a simple bloom filter, there is no way to distinguish between the two cases, but more advanced techniques can address this problem.

Removing an element from a bloom filter is impossible because false negatives are not permitted. An element maps to k bits, and although setting any one of those k bits to “0” suffices to remove the element, it also results in removing any other elements that happen to map onto that bit. Since there is no way of determining whether any other elements have been added that affect the bits for an element to be removed, clearing any of the bits would introduce the possibility for false negatives.

According to one embodiment, network device 101 includes, but is not limited to, consolidated rule generator 111 configured to receive rules 141 from applications 140. Consolidated rule generator 111 is to aggregate rules 141 into one or more sets of aggregated rules, and generate a GM match rule for each set of aggregated rules. In one embodiment, consolidated rule generator 111 is configured to aggregate rules that have similar match fields. For example, consolidated rule generator 111 aggregates a set of rules from rules 141 that have a match field indicating the source IP address is to be matched, and aggregates another set of rules from rules 141 that have a match field indicating the destination IP address is to be matched.

According to one embodiment, in order to generate a GM match rule for a corresponding set of aggregated rules, consolidated rule generator 108 generates one or more hash values by applying one or more hash functions (which may have been pre-negotiated with the network devices of forwarding plane 106) on the match fields of the corresponding set of aggregate rules. By way of example, for each rule in a set of aggregated rules, consolidated rule generator 111 applies the one or more hash functions on the match field to determine the one or more hash values. In one embodiment, each of the hash functions may be initialized with hash function parameters (e.g., seeds and/or primes that may have also been pre-negotiated). Consolidated rule generator 111 then generates/updates a GM vector for the corresponding set of aggregated set of rules by setting bits in the GM vector to a predetermined value of “1”, wherein the bits to be updated are determined based on the hash values. For example, the hash values may be used as indexes into the GM vector, identifying the bit locations that are to be updated.

In one embodiment, network device 101 then installs the GM match rules by sending them as part of consolidated rules 108 to one or more network devices (e.g., network device 102) of forwarding plane 106 via SBI 107. In one embodiment, for each GM match rule, consolidated rules 108 includes, but is not limited to, a GM match field and a GM action, wherein the GM action field identifies an action to be performed on packets identified by the GM match field. In one embodiment, the GM match field includes, but is not limited to, information indicating the rule is a GM match type, causing the receiving network device(s) to implement the rule as a GM match rule (described in further details below). The GM match field further includes information identifying the GM vector size, the GM vector value, the number of hash functions and hash function types (i.e., algorithms) that were used to update the GM vector that were used to update the GM vector, and hash function parameters (e.g., seeds, primes, etc.). As used herein, a “GM vector value” refers to the value that is represented by the bits in the GM vector. For example, the GM vector bits may represent a value in binary. Thus, the GM vector value directly indicates which bits of the GM vector are set to “1”. According to one embodiment, GM matching is to be performed on a predetermined portion of the packet headers. In another embodiment, the GM match field includes information identifying which portion of the packet headers the GM matching is to be performed on. By way of example, one GM match field may include information indicating that GM matching is to be performed on the source IP address, while another GM match field may include information indicating that GM matching is to be performed on the destination IP address. In one embodiment, the GM action field identifies an action that represents the action of the corresponding set of aggregated rules. It should be noted that each of consolidated rules 108 may include one or more GM match rules.

According to one embodiment, in response to receiving consolidated rules 108 from control plane 105, network device 102 of forwarding plane 106 implements GM matching rules based on the GM matching rule information included in the received consolidated rules. In the illustrated example, network device 102 generates GM vector 132, wherein the size of GM vector 132 is determined based on the GM vector size included in consolidated rules 108. Network device 102 generates GM vectors 133 and 143, and corresponding GM actions 134 and 144 using the GM vector values and the GM actions included in consolidated rules 108. In this example, counters 135 and 155 corresponding to GM vectors 133 and 143, respectively, are also implemented/instantiated. Network device 102 further implements hash functions 131, wherein the hashing algorithms are selected based on the hash function type information included in consolidated rules 108. In one embodiment, if hash function parameters such as seeds and/or primes are present in consolidated rules 108, network device 102 initializes hashing functions 131 with such included hash function parameters.

By way of example, network device 102 performs GM matching by applying hash function(s) 131 on packet 151 to determine one or more hash values. In one embodiment, network device 102 applies hash functions 131 on a predetermined portion of the header of packet 151. In another embodiment, network device 102 applies hash functions 131 on the portion of packet 151 as indicated in received consolidated rules 108. Network device 102 then uses the hash values to identify the bits in GM vector 132, and sets the identified bits to a value of “1”. In this example, network device 102 sets the second and fourth bit of GM vector 132 to “1”. In one embodiment, network device 102 then uses comparator 150 to compare the bits of GM vector 132 against the bits of GM vector 133. Network device 102 determines that packet 151 matches the GM match rule in response to determining all the bits that are set in GM vector 132 match (i.e., are also set in) GM vector 133. Otherwise, network device 102 determines that packet 151 does not match the GM match rule associated with GM vector 133.

In one embodiment, in response to determining a packet matches a GM match rule, network device 102 applies the corresponding GM action and updates the corresponding counter. Continuing on with the above example, in response to determining packet 151 matches the GM match rule associated with GM vector 133, network device 102 applies the action identified by associated GM action 134, and updates (e.g., increments, decrements, etc.) associated counter 135.

It should be noted that network device 102 may implement multiple GM match rules, each corresponding to a GM match rule received as part of one or more consolidated rules 108. In the illustrated example, network device 102 implements a second GM match rule, which is associated with GM vector 143, GM action 144, and counter 155. In the illustrated example, packet 151 matches the first GM match rule which is associated with GM vector 133 because GM vector 133 and GM vector 132 have the same bits that are set, and thus, network device 102 applies GM action 134 on packet 151 and updates counter 135. Packet 151 does not match, however, the second GM match rule which is associated with GM vector 143 because GM vector 143 and GM vector 132 do not have the same bits that are set, and thus, network device 102 does not apply GM action 144 on packet 151 and does not update counter 155.

In one embodiment, network devices 101 and 102 negotiate for the same set of hash functions to be used for all GM match rules that are installed. In this way, the same hash functions can be shared by the GM match rules, and thus, reducing the consumption of resources. In the illustrated example, hash functions 131 are shared by the GM match rules associated with GM vectors 133 and 143. It should be understood, however, that sharing of hash functions are not required. For example, network devices 101 and 102 may negotiate for a different set of hash functions (not shown) to be used for the second GM match rule that is associated with GM vector 143. In such an example, network device 151 would apply the second set of functions on packet 151 to derive a second set of hash values, and use the second set of hash values to update a second GM vector (not shown) instead of updating GM vector 132. Network device 102 then compares the bit settings of the second GM vector against the bit settings of GM vector 143 to determine if it matches the second GM match rule.

According to one embodiment, network device 102 may include optional counters 136. In such an embodiment, network device 102 uses the hash values to determine which (if any) of counters 136 to update. Counters 136 may provide, for example, statistics on the number of packets that are received per packet flow identified by hash functions 131. According to one embodiment, network device 102 may include optional group table 138 that includes a plurality of group entries, each of which includes a group identifier, group type, counters, and action buckets (as defined in the OpenFlow specification). In one such embodiment, in response to determining a packet (e.g., packet 151) matches a GM match rule (e.g., the GM match rule associated with GM vector 133), network device 102 may use a GM action of the matching GM rule (e.g., GM action 134) to select a group entry from group table 138. Network device 102 then uses the hash values from hash functions 131 to select an action from the action bucket of the selected group entry, and apply the selected action on the matching packet. Embodiments of the present invention shall now be described in greater details with respect to the figures below.

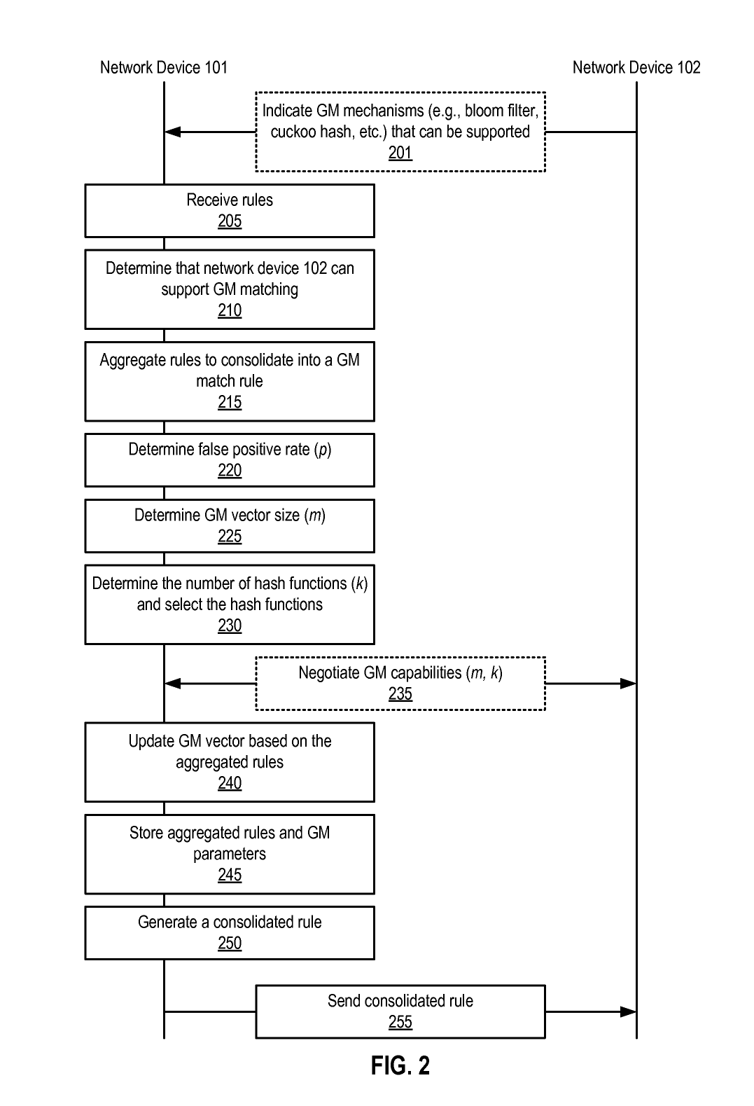

FIG. 2 is a transaction diagram illustrating operations for performing rule consolidation using a group membership test according to one embodiment. Referring now to FIG. 2, at optional operation 201, network device 102 registers with network device 101 (e.g., by using an extension to the OpenFlow protocol) and indicates the GM mechanisms that it can support. For example, as part of operation 201, network device 102 may send to network device 101 information indicating whether it supports bloom filtering, cuckoo hashing, etc. Network device 102 may also send information such as false positive rate, GM vector size, hash function types, etc. At operation 205, network device 101 receives rules (e.g., from applications 140 via NBI 109), each of which includes a match field and an action field. At operation 210, network device 101 determines that network device 102 of forwarding plane 106 can support GM rule matching. For example, network device 101 may have previously negotiated with network device 102 and stored such information locally. If, however, such information is not available to network device 101 (e.g., because network device 101 has not negotiated with network device 102), network device 101 may, as part of operation 210, negotiate with network device 102 to determine whether network device 102 can support GM matching.

At operation 215, network device 101 aggregates the received rules to consolidate into a GM match rule. In one embodiment, network device 101 aggregates a preconfigured number of rules. For example, network device 101 may wait until it has received the preconfigured number of rules, and aggregate them. Alternatively, or in addition to, network device 101 is configured to aggregate the rules periodically. For example, network device 101 waits for a preconfigured time interval, and aggregates the rules it has received during such time interval. In such an embodiment, network device 101 may limit the number of rules to aggregate to a preconfigured threshold.

At operation 220, network device 101 determines a false positive rate (p) for a GM vector. In one embodiment, the false positive rate is preconfigured by a network operator. In another embodiment, network device 101 determines the false positive rate based on the type of action that is included in the action field of the aggregated rules. For example, if the action is to forward the packet to an output port or to drop the packet, then the false positive rate may be set to a lower value. On the other hand, if the action is to count the traffic, then the false positive rate may be set to a higher value. In one embodiment, a mapping of action to false positive rate may be stored in one or more storage devices accessible by network device 101. In one such embodiment, network device 102 determines the false positive rate by using the action of the aggregated rules to index the map and lookup the false positive rate. In yet another embodiment, the false positive rate can be determined based on the supported GM mechanisms received as part of operation 201. It should be understood that network device 101 can use various other mechanisms to determine a false positive rate.

At operation 225, network device 101, using a bloom filter as a GM mechanism, determines the GM vector size (m) using an equation similar to the following equation:

$$m = - \frac{n ln p}{{( ln 2 )}^{2}} \qquad EQ ( 1 )$$

where n is the number rules to be consolidated (e.g., the number of rules aggregated as part of operation 215), and p is the false positive rate. It should be noted that if the determined GM vector size is different from the GM vector size of a previously installed GM match rule, then network device 101 may resize and re-compute the previously installed GM match rule(s).

At operation 230, network device 101, using a bloom filter as a GM mechanism, determines the number of hash functions (k) using an equation similar to the following equation:

$$k = \frac{m}{n} ln 2. \qquad EQ ( 2 )$$

At optional operation 235, network device 101 negotiates with network device 102 to determine supported GM mechanism if not yet known and whether the determined m and k are supported by network device 102. In one embodiment, as part of operation 235, network devices 101-102 also negotiate the types of hash functions (i.e., hashing algorithms) that are supported by both network devices. In one embodiment, network device 235 does not perform operation 235 if it has previously negotiated with network device 102, and the m and k previously negotiated are the same as the m and k, respectively, determined as part of operations 225 and 230.

At operation 240, network device 101 updates the GM vector associated with the aggregated rules using mechanisms similar to those described above. For example, network device 101 applies the negotiated k hash functions on the match fields of the aggregated rules to determine the hash values. Network device 102 then sets the bits in the GM vector at the location indexed/identified by the hash values to “1”.

At operation 245, network device 101 stores the aggregated rules and the GM parameters (e.g., m and k) for the GM match rule. Network device 101 may use such stored information, for example, when network device 101 needs to re-compute the GM vector because a rule needs to be removed from the GM match rule. At operation 250, network device 101 generates a consolidated rule that includes information similar to those described with respect to consolidated rules 108. At operation 255, network device 101 sends the consolidated rule to network device 101.

It should be noted that the order of the operations described herein are only intended for illustrative purposes and not intended as a limitation of the present invention. One having ordinary skill in the art would recognize that variations can be made to the transaction diagram without departing from the broader spirit and scope of the invention. Specifically, operations 225, 230, and/or 235 can be performed in various other orders. By way of example, network device 101 can perform operation 235 prior to performing operations 225 and 230. By way of further illustration, network device 101 can perform operation 230 prior to performing operation 225.

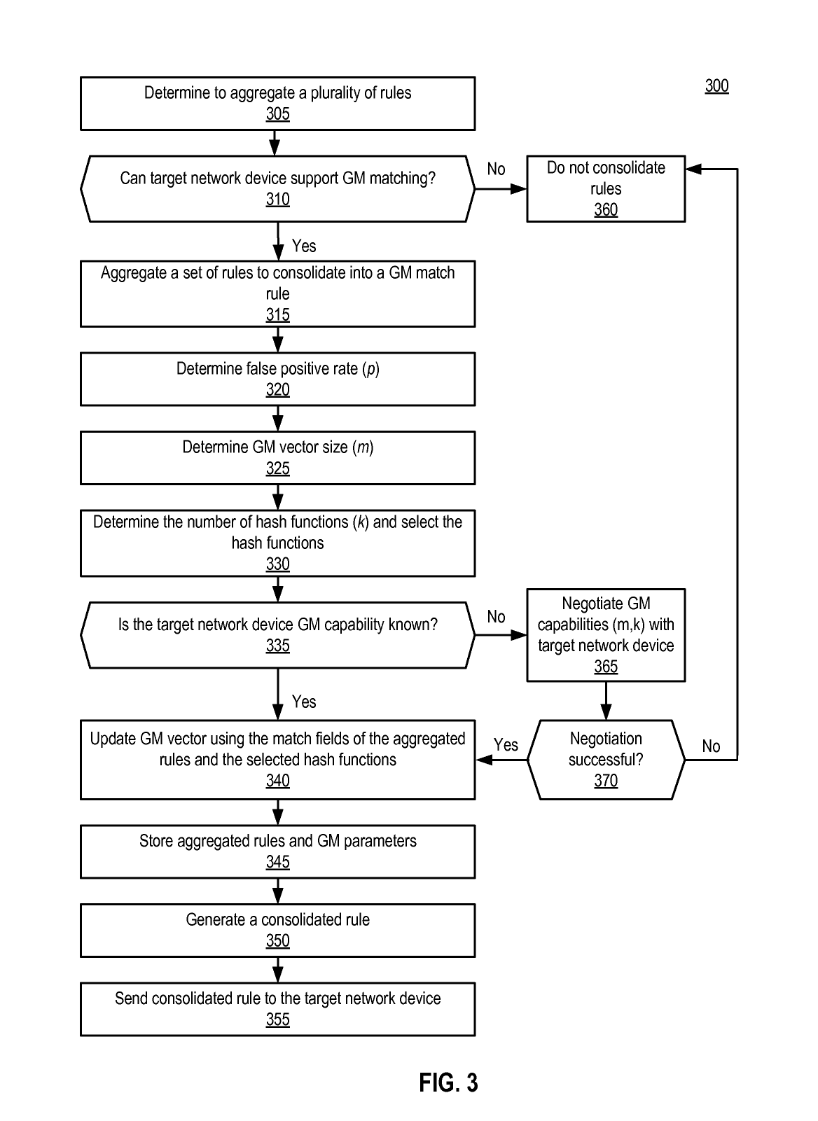

FIG. 3 is a flow diagram illustrating a method for consolidating rules using a group membership test according to one embodiment. For example, method 300 can be performed by consolidated rule generator 111. Method 300 can be implemented in software, firmware, hardware, or any combination thereof. The operations in this and other flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

Referring now to FIG. 3, at block 305, a consolidated rule generator determines to aggregate a plurality of rules. At block 310, the consolidated rule generator determines whether a target network device can support GM rule matching (e.g., as part of operation 210). At block 315 (the “Yes” branch of block 310), the consolidated rule generator aggregates a set of rules to consolidate into a GM match rule (e.g., as part of operation 215). At block 320, the consolidated rule generator determines a false positive rate (e.g., as part of operation 220).

At block 325, the consolidated rule generator determines the GM vector size (e.g., as part of block 225). At block 330, the consolidated rule generator determines the number of hash functions and selects the hash functions types/algorithms (e.g., as part of operation 230). At block 335, the consolidated rule generator determines whether the GM capability (e.g., m and k) of the target network device is known (e.g., from a previous negotiation). At block 340 (the “Yes” branch of block 335), the consolidated rule generator updates a GM vector using the match fields of the aggregated rules and the selected hash functions (e.g., as part of operation 240). At block 345, the consolidated rule generator stores the aggregated rules and GM parameters (e.g., m and k) (e.g., as part of operation 245). At block 350, the consolidated rule generator generates a consolidated rule (e.g., as part of operation 250). At block 355, the consolidated rule generator sends the consolidated rule to the target network device (e.g., as part of operation 255).

At block 360 (the “No” branch of block 310), the consolidated rule generator does not consolidate the rules. At block 365 (the “No” branch of block 335), the consolidated rule generator negotiates the supported GM mechanism if not yet known and GM capabilities (e.g., m and k) with the target network device (e.g., as part of operation 235). At block 370, the consolidated rule generator determines whether the negotiation is successful. For example, the consolidated rule generator determines whether the m and k determined as part of blocks 325 and 330, respectively, can be supported by the target network device. If not, the consolidated rule generator transitions to block 360 and does not consolidate the rules. Otherwise, the consolidated rule generator transitions to block 340 and performs the operations as described above.

It should be noted that the order of the operations described herein are only intended for illustrative purposes and not intended as a limitation of the present invention. One having ordinary skill in the art would recognize that variations can be made to the flow diagram without departing from the broader spirit and scope of the invention. Specifically, blocks 325, 330, and/or 365 can be performed in various other orders.

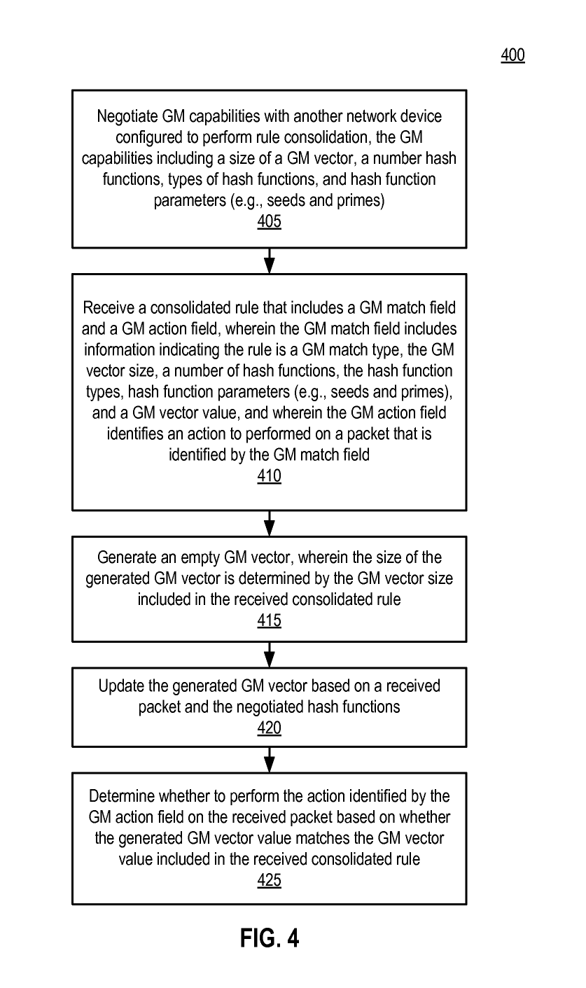

FIG. 4 is a flow diagram illustrating a method for consolidating rules using a group membership test according to one embodiment. For example, method 400 can be performed by network device 102. Method 400 can be implemented in software, firmware, hardware, or any combination thereof. Referring now to FIG. 4, at block 405, a network device negotiates supported GM mechanism if not yet known and GM capabilities with another network device configured to perform rule consolidation, the GM capabilities including a size of a GM vector, a number hash functions, the types of hash functions, and hash function parameters (e.g., as part of operation 235).

At block 410, the network device receives a consolidated rule that includes a GM match field and a GM action field, wherein the GM match field includes information indicating the rule is a GM match type, the GM vector size, a number of hash functions, the hash function types, hash function parameters (e.g., seeds and primes), and a GM vector value, and wherein the GM action field identifies an action to performed on a packet that is identified by the GM match field. For example, network device 102 receives consolidated rules 108 from network device 101. At block 415, the network device generates an empty GM vector, wherein the size of the generated GM vector is determined by the GM vector size included in the received consolidated rule. For example, network device 102 generates empty GM vector 132 based on the GM vector size included in received consolidated rules 108.

At block 420, the network device updates the generated GM vector based on a received packet and the negotiated hash functions. For example, network device 102 applies hash functions 131 on packet 151 to determine hash values. Network device 102 then sets the bits in GM vector 132 at the locations identified by the hash values to “1”.

At block 425, the network device determines whether to perform the action identified by the GM action field on the received packet based on whether the generated GM vector value matches the GM vector value included in the received consolidated rule. For example, network device 102 uses comparator 150 to compare the value of GM vector 132 against the value of GM vector 133 (i.e., to determine whether the same set of bits are set in both GM vectors). Network device 102 performs the action identified by associated GM action 134 in response to determining GM vector 132 and GM vector 133 contain the same set of bits that are set. Network device 102 does not perform the action, however, if GM vector 132 and GM vector 133 do not match.

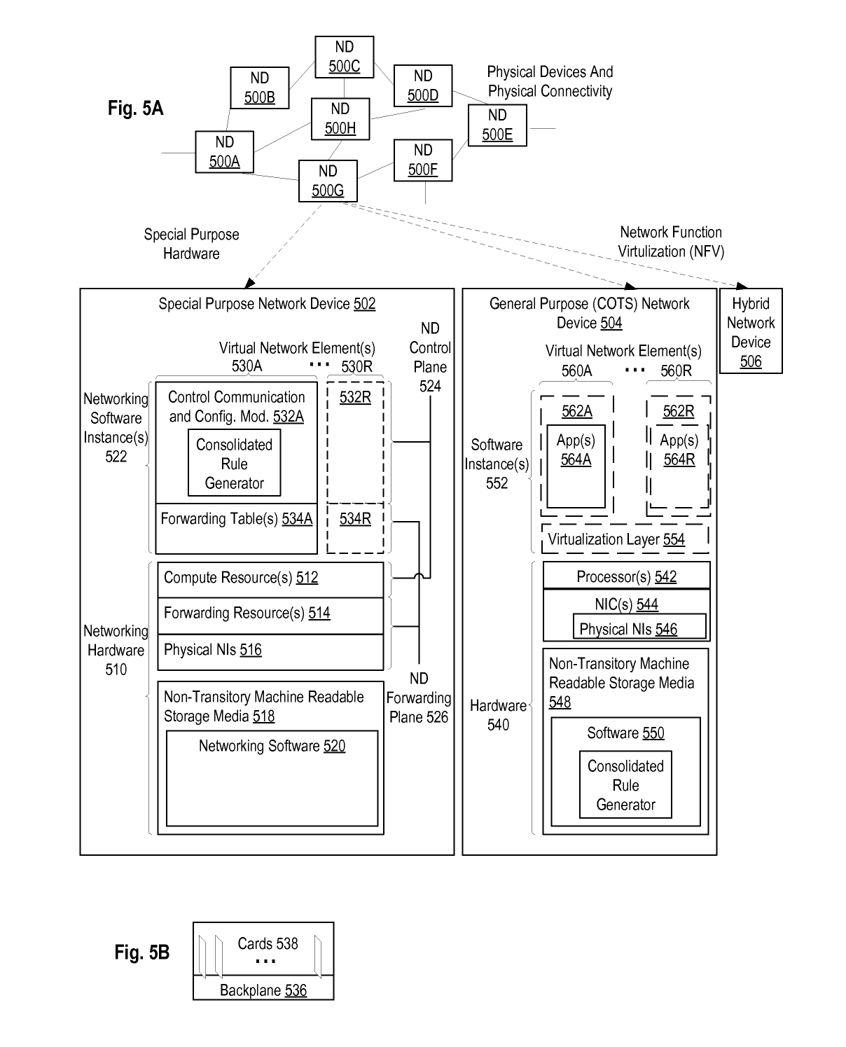

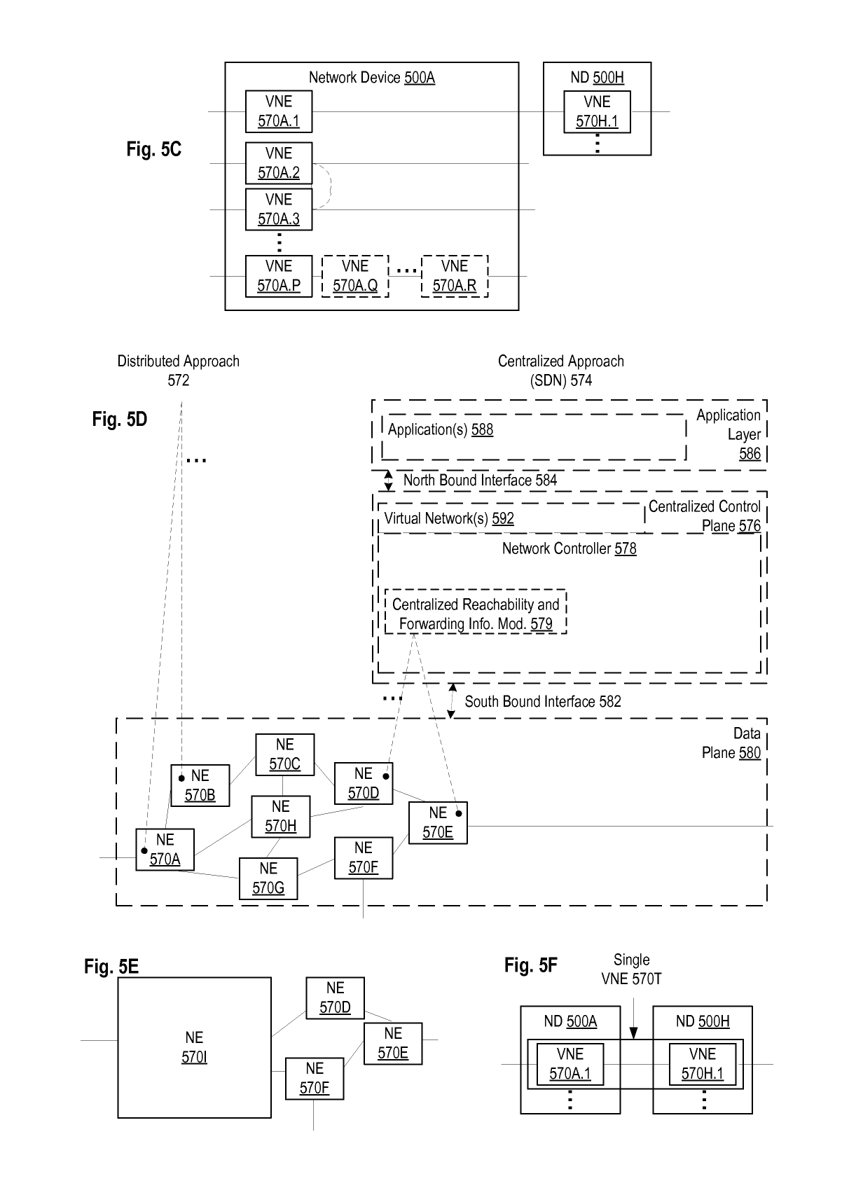

FIG. 5A illustrates connectivity between network devices (NDs) within an exemplary network, as well as three exemplary implementations of the NDs, according to some embodiments of the invention. FIG. 5A shows NDs 500A-H, and their connectivity by way of lines between A-B, B-C, C-D, D-E, E-F, F-G, and A-G, as well as between H and each of A, C, D, and G. These NDs are physical devices, and the connectivity between these NDs can be wireless or wired (often referred to as a link). An additional line extending from NDs 500A, E, and F illustrates that these NDs act as ingress and egress points for the network (and thus, these NDs are sometimes referred to as edge NDs; while the other NDs may be called core NDs).

Two of the exemplary ND implementations in FIG. 5A are: 1) a special-purpose network device 502 that uses custom application—specific integrated—circuits (ASICs) and a proprietary operating system (OS); and 2) a general purpose network device 504 that uses common off-the-shelf (COTS) processors and a standard OS.

The special-purpose network device 502 includes networking hardware 510 comprising compute resource(s) 512 (which typically include a set of one or more processors), forwarding resource(s) 514 (which typically include one or more ASICs and/or network processors), and physical network interfaces (NIs) 516 (sometimes called physical ports), as well as non-transitory machine readable storage media 518 having stored therein networking software 520. A physical NI is hardware in a ND through which a network connection (e.g., wirelessly through a wireless network interface controller (WNIC) or through plugging in a cable to a physical port connected to a network interface controller (NIC)) is made, such as those shown by the connectivity between NDs 500A-H. During operation, the networking software 520 may be executed by the networking hardware 510 to instantiate a set of one or more networking software instance(s) 522. Each of the networking software instance(s) 522, and that part of the networking hardware 510 that executes that network software instance (be it hardware dedicated to that networking software instance and/or time slices of hardware temporally shared by that networking software instance with others of the networking software instance(s) 522), form a separate virtual network element 530A-R. Each of the virtual network element(s) (VNEs) 530A-R includes a control communication and configuration module 532A-R (sometimes referred to as a local control module or control communication module) and forwarding table(s) 534A-R, such that a given virtual network element (e.g., 530A) includes the control communication and configuration module (e.g., 532A), a set of one or more forwarding table(s) (e.g., 534A), and that portion of the networking hardware 510 that executes the virtual network element (e.g., 530A).

Software 520 can include code which when executed by networking hardware 510, causes networking hardware 510 to perform operations of one or more embodiments of the present invention as part networking software instances 522.

The special-purpose network device 502 is often physically and/or logically considered to include: 1) a ND control plane 524 (sometimes referred to as a control plane) comprising the compute resource(s) 512 that execute the control communication and configuration module(s) 532A-R; and 2) a ND forwarding plane 526 (sometimes referred to as a forwarding plane, a data plane, or a media plane) comprising the forwarding resource(s) 514 that utilize the forwarding table(s) 534A-R and the physical NIs 516. By way of example, where the ND is a router (or is implementing routing functionality), the ND control plane 524 (the compute resource(s) 512 executing the control communication and configuration module(s) 532A-R) is typically responsible for participating in controlling how data (e.g., packets) is to be routed (e.g., the next hop for the data and the outgoing physical NI for that data) and storing that routing information in the forwarding table(s) 534A-R, and the ND forwarding plane 526 is responsible for receiving that data on the physical NIs 516 and forwarding that data out the appropriate ones of the physical NIs 516 based on the forwarding table(s) 534A-R.

FIG. 5B illustrates an exemplary way to implement the special-purpose network device 502 according to some embodiments of the invention. FIG. 5B shows a special-purpose network device including cards 538 (typically hot pluggable). While in some embodiments the cards 538 are of two types (one or more that operate as the ND forwarding plane 526 (sometimes called line cards), and one or more that operate to implement the ND control plane 524 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 536 (e.g., a first full mesh coupling the line cards and a second full mesh coupling all of the cards).

Returning to FIG. 5A, the general purpose network device 504 includes hardware 540 comprising a set of one or more processor(s) 542 (which are often COTS processors) and network interface controller(s) 544 (NICs; also known as network interface cards) (which include physical NIs 546), as well as non-transitory machine readable storage media 548 having stored therein software 550. During operation, the processor(s) 542 execute the software 550 to instantiate one or more sets of one or more applications 564A-R. While one embodiment does not implement virtualization, alternative embodiments may use different forms of virtualization—represented by a virtualization layer 554 and software containers 562A-R. For example, one such alternative embodiment implements operating system-level virtualization, in which case the virtualization layer 554 represents the kernel of an operating system (or a shim executing on a base operating system) that allows for the creation of multiple software containers 562A-R that may each be used to execute one of the sets of applications 564A-R. In this embodiment, the multiple software containers 562A-R (also called virtualization engines, virtual private servers, or jails) are each a user space instance (typically a virtual memory space); these user space instances are separate from each other and separate from the kernel space in which the operating system is run; the set of applications running in a given user space, unless explicitly allowed, cannot access the memory of the other processes, Another such alternative embodiment implements full virtualization, in which case: 1) the virtualization layer 554 represents a hypervisor (sometimes referred to as a virtual machine monitor (VMM)) or a hypervisor executing on top of a host operating system; and 2) the software containers 562A-R each represent a tightly isolated form of software container called a virtual machine that is run by the hypervisor and may include a guest operating system. A virtual machine is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes.

The instantiation of the one or more sets of one or more applications 564A-R, as well as the virtualization layer 554 and software containers 562A-R if implemented, are collectively referred to as software instance(s) 552. Each set of applications 564A-R, corresponding software container 562A-R if implemented, and that part of the hardware 540 that executes them (be it hardware dedicated to that execution and/or time slices of hardware temporally shared by software containers 562A-R), forms a separate virtual network element(s) 560A-R.

The virtual network element(s) 560A-R perform similar functionality to the virtual network element(s) 530A-R—e.g., similar to the control communication and configuration module(s) 532A and forwarding table(s) 534A (this virtualization of the hardware 540 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). However, different embodiments of the invention may implement one or more of the software container(s) 562A-R differently. For example, while embodiments of the invention are illustrated with each software container 562A-R corresponding to one VNE 560A-R, alternative embodiments may implement this correspondence at a finer level granularity (e.g., line card virtual machines virtualize line cards, control card virtual machine virtualize control cards, etc.); it should be understood that the techniques described herein with reference to a correspondence of software containers 562A-R to VNEs also apply to embodiments where such a finer level of granularity is used.

In certain embodiments, the virtualization layer 554 includes a virtual switch that provides similar forwarding services as a physical Ethernet switch. Specifically, this virtual switch forwards traffic between software containers 562A-R and the NIC(s) 544, as well as optionally between the software containers 562A-R; in addition, this virtual switch may enforce network isolation between the VNEs 560A-R that by policy are not permitted to communicate with each other (e.g., by honoring virtual local area networks (VLANs)).

Software 550 can include code which when executed by processor(s) 542, cause processor(s) 542 to perform operations of one or more embodiments of the present invention as part software containers 562A-R.

The third exemplary ND implementation in FIG. 5A is a hybrid network device 506, which includes both custom ASICs/proprietary OS and COTS processors/standard OS in a single ND or a single card within an ND. In certain embodiments of such a hybrid network device, a platform VM (i.e., a VM that that implements the functionality of the special-purpose network device 502) could provide for para-virtualization to the networking hardware present in the hybrid network device 506.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 530A-R, VNEs 560A-R, and those in the hybrid network device 506) receives data on the physical NIs (e.g., 516, 546) and forwards that data out the appropriate ones of the physical NIs (e.g., 516, 546). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services (DSCP) values.

FIG. 5C illustrates various exemplary ways in which VNEs may be coupled according to some embodiments of the invention. FIG. 5C shows VNEs 570A.1-570A.P (and optionally VNEs 570A.Q-570A.R) implemented in ND 500A and VNE 570H.1 in ND 500H. In FIG. 5C, VNEs 570A.1-P are separate from each other in the sense that they can receive packets from outside ND 500A and forward packets outside of ND 500A; VNE 570A.1 is coupled with VNE 570H.1, and thus they communicate packets between their respective NDs; VNE 570A.2-570A.3 may optionally forward packets between themselves without forwarding them outside of the ND 500A; and VNE 570A.P may optionally be the first in a chain of VNEs that includes VNE 570A.Q followed by VNE 570A.R (this is sometimes referred to as dynamic service chaining, where each of the VNEs in the series of VNEs provides a different service—e.g., one or more layer 4-7 network services). While FIG. 5C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 5A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 5A may also host one or more such servers (e.g., in the case of the general purpose network device 504, one or more of the software containers 562A-R may operate as servers; the same would be true for the hybrid network device 506; in the case of the special-purpose network device 502, one or more such servers could also be run on a virtualization layer executed by the compute resource(s) 512); in which case the servers are said to be co-located with the VNEs of that ND.

A virtual network is a logical abstraction of a physical network (such as that in FIG. 5A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network—originated attacks, to avoid malformed route announcements), and management capabilities (e.g., full detection and processing).

FIG. 5D illustrates a network with a single network element on each of the NDs of FIG. 5A, and within this straight forward approach contrasts a traditional distributed approach (commonly used by traditional routers) with a centralized approach for maintaining reachability and forwarding information (also called network control), according to some embodiments of the invention. Specifically, FIG. 5D illustrates network elements (NEs) 570A-H with the same connectivity as the NDs 500A-H of FIG. 5A.

FIG. 5D illustrates that the distributed approach 572 distributes responsibility for generating the reachability and forwarding information across the NEs 570A-H; in other words, the process of neighbor discovery and topology discovery is distributed.

For example, where the special-purpose network device 502 is used, the control communication and configuration module(s) 532A-R of the ND control plane 524 typically include a reachability and forwarding information module to implement one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP)), Label Distribution Protocol (LDP), Resource Reservation Protocol (RSVP), as well as RSVP-Traffic Engineering (TE): Extensions to RSVP for LSP Tunnels, Generalized Multi-Protocol Label Switching (GMPLS) Signaling RSVP-TE that communicate with other NEs to exchange routes, and then selects those routes based on one or more routing metrics. Thus, the NEs 570A-H (e.g., the compute resource(s) 512 executing the control communication and configuration module(s) 532A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 524. The ND control plane 524 programs the ND forwarding plane 526 with information (e.g., adjacency and route information) based on the routing structure(s). For example, the ND control plane 524 programs the adjacency and route information into one or more forwarding table(s) 534A-R (e.g., Forwarding Information Base (FIB), Label Forwarding Information Base (LFIB), and one or more adjacency structures) on the ND forwarding plane 526. For layer 2 forwarding, the ND can store one or more bridging tables that are used to forward data based on the layer 2 information in that data. While the above example uses the special-purpose network device 502, the same distributed approach 572 can be implemented on the general purpose network device 504 and the hybrid network device 506.

FIG. 5D illustrates that a centralized approach 574 (also known as software defined networking (SDN)) that decouples the system that makes decisions about where traffic is sent from the underlying systems that forwards traffic to the selected destination. The illustrated centralized approach 574 has the responsibility for the generation of reachability and forwarding information in a centralized control plane 576 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 576 has a south bound interface 582 with a data plane 580 (sometime referred to the infrastructure layer, network forwarding plane, or forwarding plane (which should not be confused with a ND forwarding plane)) that includes the NEs 570A-H (sometimes referred to as switches, forwarding elements, data plane elements, or nodes). The centralized control plane 576 includes a network controller 578, which includes a centralized reachability and forwarding information module 579 that determines the reachability within the network and distributes the forwarding information to the NEs 570A-H of the data plane 580 over the south bound interface 582 (which may use the OpenFlow protocol). Thus, the network intelligence is centralized in the centralized control plane 576 executing on electronic devices that are typically separate from the NDs.

For example, where the special-purpose network device 502 is used in the data plane 580, each of the control communication and configuration module(s) 532A-R of the ND control plane 524 typically include a control agent that provides the VNE side of the south bound interface 582. In this case, the ND control plane 524 (the compute resource(s) 512 executing the control communication and configuration module(s) 532A-R) performs its responsibility for participating in controlling how data (e.g., packets) is to be routed (e.g., the next hop for the data and the outgoing physical NI for that data) through the control agent communicating with the centralized control plane 576 to receive the forwarding information (and in some cases, the reachability information) from the centralized reachability and forwarding information module 579 (it should be understood that in some embodiments of the invention, the control communication and configuration module(s) 532A-R, in addition to communicating with the centralized control plane 576, may also play some role in determining reachability and/or calculating forwarding information—albeit less so than in the case of a distributed approach; such embodiments are generally considered to fall under the centralized approach 574, but may also be considered a hybrid approach).

While the above example uses the special-purpose network device 502, the same centralized approach 574 can be implemented with the general purpose network device 504 (e.g., each of the VNE 560A-R performs its responsibility for controlling how data (e.g., packets) is to be routed (e.g., the next hop for the data and the outgoing physical NI for that data) by communicating with the centralized control plane 576 to receive the forwarding information (and in some cases, the reachability information) from the centralized reachability and forwarding information module 579; it should be understood that in some embodiments of the invention, the VNEs 560A-R, in addition to communicating with the centralized control plane 576, may also play some role in determining reachability and/or calculating forwarding information—albeit less so than in the case of a distributed approach) and the hybrid network device 506. In fact, the use of SDN techniques can enhance the NFV techniques typically used in the general purpose network device 504 or hybrid network device 506 implementations as NFV is able to support SDN by providing an infrastructure upon which the SDN software can be run, and NFV and SDN both aim to make use of commodity server hardware and physical switches.

FIG. 5D also shows that the centralized control plane 576 has a north bound interface 584 to an application layer 586, in which resides application(s) 588. The centralized control plane 576 has the ability to form virtual networks 592 (sometimes referred to as a logical forwarding plane, network services, or overlay networks (with the NEs 570A-H of the data plane 580 being the underlay network)) for the application(s) 588. Thus, the centralized control plane 576 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

While FIG. 5D shows the distributed approach 572 separate from the centralized approach 574, the effort of network control may be distributed differently or the two combined in certain embodiments of the invention. For example: 1) embodiments may generally use the centralized approach (SDN) 574, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 574, but may also be considered a hybrid approach.

While FIG. 5D illustrates the simple case where each of the NDs 500A-H implements a single NE 570A-H, it should be understood that the network control approaches described with reference to FIG. 5D also work for networks where one or more of the NDs 500A-H implement multiple VNEs (e.g., VNEs 530A-R, VNEs 560A-R, those in the hybrid network device 506). Alternatively or in addition, the network controller 578 may also emulate the implementation of multiple VNEs in a single ND. Specifically, instead of (or in addition to) implementing multiple VNEs in a single ND, the network controller 578 may present the implementation of a VNE/NE in a single ND as multiple VNEs in the virtual networks 592 (all in the same one of the virtual network(s) 592, each in different ones of the virtual network(s) 592, or some combination). For example, the network controller 578 may cause an ND to implement a single VNE (a NE) in the underlay network, and then logically divide up the resources of that NE within the centralized control plane 576 to present different VNEs in the virtual network(s) 592 (where these different VNEs in the overlay networks are sharing the resources of the single VNE/NE implementation on the ND in the underlay network).

On the other hand, FIGS. 5E and 5F respectively illustrate exemplary abstractions of NEs and VNEs that the network controller 578 may present as part of different ones of the virtual networks 592. FIG. 5E illustrates the simple case of where each of the NDs 500A-H implements a single NE 570A-H (see FIG. 5D), but the centralized control plane 576 has abstracted multiple of the NEs in different NDs (the NEs 570A-C and G-H) into (to represent) a single NE 5701 in one of the virtual network(s) 592 of FIG. 5D, according to some embodiments of the invention. FIG. 5E shows that in this virtual network, the NE 5701 is coupled to NE 570D and 570F, which are both still coupled to NE 570E.

FIG. 5F illustrates a case where multiple VNEs (VNE 570A.1 and VNE 570H.1) are implemented on different NDs (ND 500A and ND 500H) and are coupled to each other, and where the centralized control plane 576 has abstracted these multiple VNEs such that they appear as a single VNE 570T within one of the virtual networks 592 of FIG. 5D, according to some embodiments of the invention. Thus, the abstraction of a NE or VNE can span multiple NDs.

While some embodiments of the invention implement the centralized control plane 576 as a single entity (e.g., a single instance of software running on a single electronic device), alternative embodiments may spread the functionality across multiple entities for redundancy and/or scalability purposes (e.g., multiple instances of software running on different electronic devices).

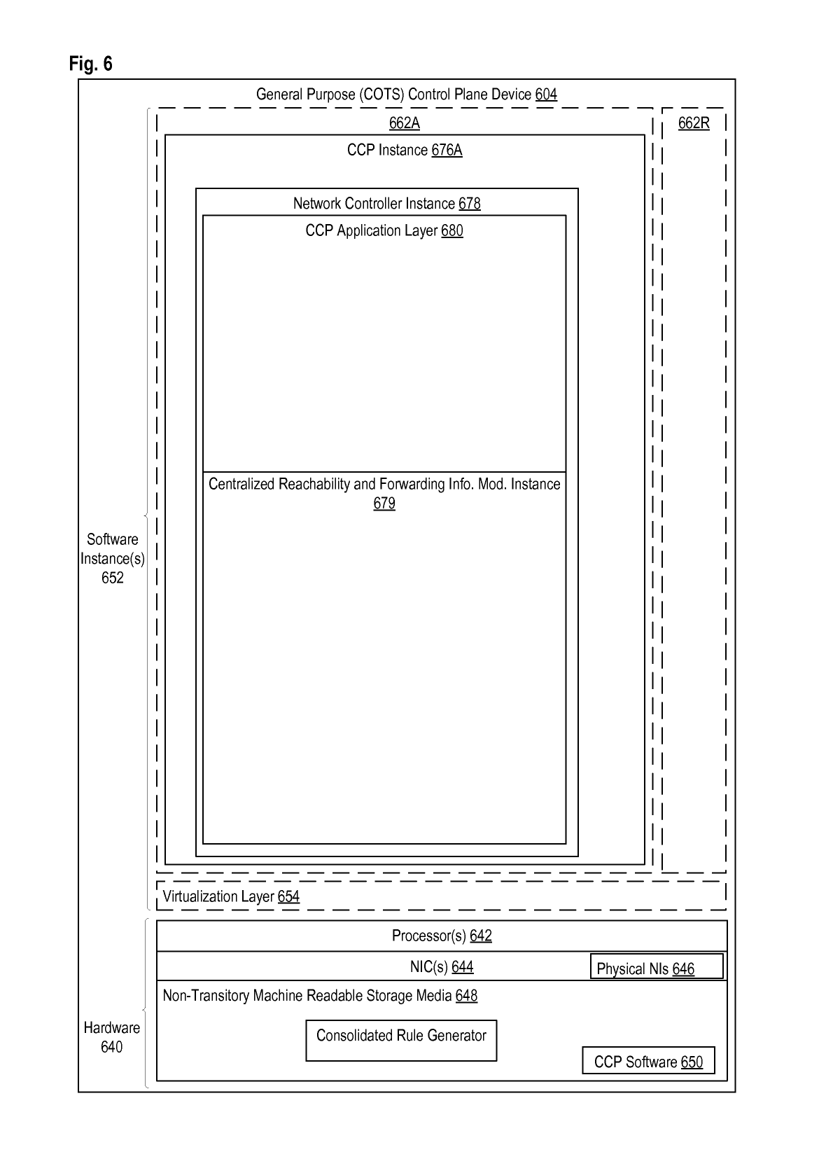

Similar to the network device implementations, the electronic device(s) running the centralized control plane 576, and thus the network controller 578 including the centralized reachability and forwarding information module 579, may be implemented a variety of ways (e.g., a special purpose device, a general-purpose (e.g., COTS) device, or hybrid device). These electronic device(s) would similarly include compute resource(s), a set or one or more physical NICs, and a non-transitory machine-readable storage medium having stored thereon the centralized control plane software. For instance, FIG. 6 illustrates, a general purpose control plane device 604 including hardware 640 comprising a set of one or more processor(s) 642 (which are often COTS processors) and network interface controller(s) 644 (NICs; also known as network interface cards) (which include physical NIs 646), as well as non-transitory machine readable storage media 648 having stored therein centralized control plane (CCP) software 650.

In embodiments that use compute virtualization, the processor(s) 642 typically execute software to instantiate a virtualization layer 654 and software container(s) 662A-R (e.g., with operating system-level virtualization, the virtualization layer 654 represents the kernel of an operating system (or a shim executing on a base operating system) that allows for the creation of multiple software containers 662A-R (representing separate user space instances and also called virtualization engines, virtual private servers, or jails) that may each be used to execute a set of one or more applications; with full virtualization, the virtualization layer 654 represents a hypervisor (sometimes referred to as a virtual machine monitor (VMM)) or a hypervisor executing on top of a host operating system, and the software containers 662A-R each represent a tightly isolated form of software container called a virtual machine that is run by the hypervisor and may include a guest operating system; with para-virtualization, an operating system or application running with a virtual machine may be aware of the presence of virtualization for optimization purposes). Again, in embodiments where compute virtualization is used, during operation an instance of the CCP software 650 (illustrated as CCP instance 676A) is executed within the software container 662A on the virtualization layer 654. In embodiments where compute virtualization is not used, the CCP instance 676A on top of a host operating system is executed on the “bare metal” general purpose control plane device 604. The instantiation of the CCP instance 676A, as well as the virtualization layer 654 and software containers 662A-R if implemented, are collectively referred to as software instance(s) 652.

In some embodiments, the CCP instance 676A includes a network controller instance 678. The network controller instance 678 includes a centralized reachability and forwarding information module instance 679 (which is a middleware layer providing the context of the network controller 578 to the operating system and communicating with the various NEs), and an CCP application layer 680 (sometimes referred to as an application layer) over the middleware layer (providing the intelligence required for various network operations such as protocols, network situational awareness, and user—interfaces). At a more abstract level, this CCP application layer 680 within the centralized control plane 576 works with virtual network view(s) (logical view(s) of the network) and the middleware layer provides the conversion from the virtual networks to the physical view.

The centralized control plane 576 transmits relevant messages to the data plane 580 based on CCP application layer 680 calculations and middleware layer mapping for each flow. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 10 or more) in the packet headers. Different NDs/NEs/VNEs of the data plane 580 may receive different messages, and thus different forwarding information. The data plane 580 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 580, the packet (or a subset of the packet header and content) is typically forwarded to the centralized control plane 576. The centralized control plane 576 will then program forwarding table entries into the data plane 580 to accommodate packets belonging to the flow of the unknown packet. Once a specific forwarding table entry has been programmed into the data plane 580 by the centralized control plane 576, the next packet with matching credentials will match that forwarding table entry and take the set of actions associated with that matched entry.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

Throughout the description, embodiments of the present invention have been presented through flow diagrams. It will be appreciated that the order of transactions and transactions described in these flow diagrams are only intended for illustrative purposes and not intended as a limitation of the present invention. One having ordinary skill in the art would recognize that variations can be made to the flow diagrams without departing from the broader spirit and scope of the invention as set forth in the following claims.

The invention claimed is:

1. A method in a first network device that is communicatively coupled to a second network device, for consolidating rules, the method comprising:
determining to consolidate a plurality of rules, wherein each rule comprises a match field and an action field, wherein the action field identifies an action to be performed on packets identified by the match field;
selecting one or more hash functions, wherein a number of hash functions selected is determined based on a number of rules in the plurality of rules;
updating group membership (GM) vector based on the plurality of rules and the selected hash functions;
generating a consolidated rule comprising a GM match field and a GM action field, wherein the GM match field comprises the GM vector, wherein the GM action field identifies an action to be performed on packets identified by the GM match field; and
sending the consolidated rule to the second network device.

2. The method according to claim 28, further comprising:
negotiating with the second network device to determine that the second network device can support the determined GM vector size and the selected hash functions.

3. The method according to claim 1, further comprising:
selecting hash function parameters comprising a seed and a prime for each of the selected hash functions; and
negotiating with the second network device to determine that the second network device can support the selected hash function parameters.

4. The method according to claim 1, wherein the GM match field of the consolidated rule further comprises information identifying the selected hash functions.

5. The method according to claim 1, wherein updating the GM vector comprises:
for each of the plurality of rules:
applying the selected one or more hash functions to obtain one or more hash values, and
setting one or more bits in the GM vector based on the determined one or more hash values.

6. A first network device that is communicatively coupled to a second network device, for consolidating rules, the first network device comprising:
a set of one or more processors; and
a non-transitory machine-readable storage medium containing code, which when executed by the set of one or more processors, causes the first network device to:
determine to consolidate a plurality of rules, wherein each rule comprises a match field and an action field, wherein the action field identifies an action to be performed on packets identified by the match field,
select one or more hash functions, wherein a number of hash functions selected is determined based on a number of rules in the plurality of rules,
update a group membership (GMS vector based on the plurality of rules and the selected hash functions,
generate a consolidated rule comprising a GM match field and a GM action field, wherein the GM match field comprises the GM vector, wherein the GM action field identifies an action to be performed on packets identified by the GM match field, and
send the consolidated rule to the second network device.

7. The first network device according to claim 29,
wherein the non-transitory machine-readable storage medium further contains code, which when executed by the set of one or more processors, causes the first network device to:
negotiate with the second network device to determine that the second network device can support the determined GM vector size and the selected hash functions.

8. The first network device according to claim 6, wherein the non-transitory machine-readable storage medium further contains code, which when executed by the set of one or more processors, causes the first network device to:
select hash function parameters comprising a seed and a prime for each of the selected hash functions; and
negotiate with the second network device to determine that the second network device can support the selected hash function parameters.

9. The first network device according to claim 6, wherein the GM match field of the consolidated rule further comprises information identifying the selected hash functions.

10. The first network device according to claim 6, wherein updating the GM vector comprises the first network device to:
for each of the plurality of rules:
apply the selected one or more hash functions to obtain one or more hash values, and
set one or more bits in the GM vector based on the determined one or more hash values.

11. A non-transitory machine-readable storage medium having computer code stored therein, which when executed by a set of one or more processors of a first network device that is communicatively coupled to a second network device, for consolidating rules, causes the first network device to perform operations comprising:
determining to consolidate a plurality of rules, wherein each rule comprises a match field and an action field, wherein the action field identifies an action to be performed on packets identified by the match field;
selecting one or more hash functions, wherein a number of hash functions selected is determined based on a number of rules in the plurality of rules;
updating a group membership (GM) vector based on the plurality of rules and the selected hash functions;
generating a consolidated rule comprising a GM match field and a GM action field, wherein the GM match field comprises the GM vector, wherein the GM action field identifies an action to be performed on packets identified by the GM match field; and
sending the consolidated rule to the second network device.

12. The non-transitory machine-readable storage medium according to claim 30, further comprising:
negotiating with the second network device to determine that the second network device can support the determined GM vector size and the selected hash functions.

13. The non-transitory machine-readable storage medium according to claim 11, further comprising:
selecting hash function parameters comprising a seed and a prime for each of the selected hash functions; and
negotiating with the second network device to determine that the second network device can support the selected hash function parameters.

14. The non-transitory machine-readable storage medium according to claim 11, wherein the GM match field of the consolidated rule further comprises information identifying the selected hash functions.

15. The non-transitory machine-readable storage medium according to claim 11, wherein updating the GM vector comprises:
for each of the plurality of rules:
applying the selected one or more hash functions to obtain one or more hash values, and
setting one or more bits in the GM vector based on the determined one or more hash values.

16. A method in a first network device that is communicatively coupled to a second network device, for consolidating rules, the method comprising:
negotiating with the second network device to determine a size of a group membership (GM) vector; and
receiving a consolidated rule comprising a GM match field and a GM action field, wherein the GM match field comprises the GM vector, wherein the GM action field identifies an action to be performed on packets identified by the GM match field.

17. The method according to claim 16, further comprising:
in response to receiving a packet, determining one or more hash values by applying one or more hash functions on one or more bytes in a header of the received packet;
updating a second GM vector based on the determined one or more hash values; and
determining whether to perform the action identified by the GM action field on the packet based on whether the second GM vector matches the GM vector included in the GM match field of the received consolidated rule.

18. The method according to claim 17, further comprising:
updating one or more counters identified by the determined one or more hash values.

19. The method according to claim 17, further comprising:
negotiating with the second network device to determine the one or more hash functions; and wherein
the GM match field of the received consolidated rule further comprises information identifying the one or more hash functions.

20. A first network device that is communicatively coupled to a second network device, for consolidating rules, the first network device comprising:
a set of one or more processors; and
a non-transitory machine-readable storage medium containing code, which when executed by the set of one or more processors, causes the first network device to:
negotiate with the second network device to determine a size of a group membership (GM) vector, and
receive a consolidated rule comprising a GM match field and a GM action field, wherein the GM match field comprises the GM vector, wherein the GM action field identifies an action to be performed on packets identified by the GM match field.

21. The first network device according to claim 20, wherein the non-transitory machine-readable storage medium further contains code, which when executed by the set of one or more processors, causes the first network device to:
in response to receiving a packet, determine one or more hash values by applying one or more hash functions on one or more bytes in a header of the received packet;
update a second GM vector based on the determined one or more hash values; and
determine whether to perform the action identified by the GM action field on the packet based on whether the second GM vector matches the GM vector included in the GM match field of the received consolidated rule.

22. The first network device according to claim 21, wherein the non-transitory machine-readable storage medium further contains code, which when executed by the set of one or more processors, causes the first network device to:
update one or more counters identified by the determined one or more hash values.

23. The first network device according to claim 21,
wherein the non-transitory machine-readable storage medium further contains code, which when executed by the set of one or more processors, causes the first network device to:
negotiate with the second network device to determine the one or more hash functions; and wherein
the GM match field of the received consolidated rule further comprises information identifying the one or more hash functions.

24. A non-transitory machine-readable storage medium having computer code stored therein, which when executed by a set of one or more processors of a first network device that is communicatively coupled to a second network device, for consolidating rules, causes the first network device to perform operations comprising:
negotiating with the second network device to determine a size of a group membership (GM) vector; and
receiving a consolidated rule comprising a GM match field and a GM action field, wherein the GM match field comprises the GM vector, wherein the GM action field identifies an action to be performed on packets identified by the GM match field.

25. The non-transitory machine-readable storage medium according to claim 24, further comprising:
in response to receiving a packet, determining one or more hash values by applying one or more hash functions on one or more bytes in a header of the received packet;
updating a second GM vector based on the determined one or more hash values; and
determining whether to perform the action identified by the GM action field on the packet based on whether the second GM vector matches the GM vector included in the GM match field of the received consolidated rule.

26. The non-transitory machine-readable storage medium according to claim 25, further comprising:
updating one or more counters identified by the determined one or more hash values.

27. The non-transitory machine-readable storage medium according to claim 25, further comprising:
negotiating with the second network device to determine the one or more hash functions; and wherein
the GM match field of the received consolidated rule further comprises information identifying the one or more hash functions.

28. The method according to claim 1, further comprising:
determining a false positive rate; and
determining a size of the GM vector based on the number of rules in the plurality of rules.

29. The first network device according to claim 6, wherein the non-transitory machine-readable storage medium further contains code, which when executed by the set of one or more processors, causes the first network device to:
determine a false positive rate; and
determine a size of the GM vector based on the number of rules in the plurality of rules.

30. The non-transitory machine-readable storage medium according to claim 11, wherein the operations further comprise:
determining a false positive rate; and
determining a size of the GM vector based on the number of rules in the plurality of rules.
